(19) United States
(12) Patent Application Publication
(10) Pub. No.: US 2006/0071641 A1
(43) Pub. Date: Apr. 6, 2006

(54) Collapsible battery charger

(76) Inventor: Grahame P. Ward, Marcellus, NY (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 10/955,667

(22) Filed: Sep. 30, 2004

(51) Int. Cl. H02J 7/00

(52) U.S. Cl. 320/116

(57) ABSTRACT

A collapsible battery charger is provided for charging batteries each having a pair of contact terminals on opposite ends. The battery charger includes a housing structure having a first upstanding wall and a sliding tray having a bottom wall and a second upstanding wall which is generally parallel to the first upstanding wall. The sliding tray is movable between a first position in which the first and second upstanding walls are adjacent to each other and a second position in which the first and second walls are spaced from one another. The tray is configured to hold one or more batteries for charging. The battery charger further includes at least one pair of contacts including a first contact provided on the first upstanding wall and a second contact provided on the second upstanding wall. The first and second contacts are adapted to contact the first and second contact terminals of a battery.

### BACKGROUND OF THE INVENTION

The present invention generally relates to battery charging devices and, more particularly, relates to a compact, collapsible sliding drawer-type battery charger.

Rechargeable (secondary) batteries, such as nickel-metal hydride (Ni-MH) and nickel-cadmium (Ni—Cd) electrochemical cells, are generally designed to be recharged by applying an electrical charging current to the positive and negative battery terminals. To perform battery recharging, a battery charger is employed which generally includes electrical charge contact terminals configured to contact the positive and negative terminals of a battery to provide an electrical current charging path. Conventional battery chargers are known to charge an individual battery or a plurality of batteries simultaneously.

Many conventional battery chargers are generally large in size and therefore consume a significant amount of space. Such battery chargers typically have a main housing containing electrical charging circuitry and a battery holding compartment extending from the main housing. The large size chargers are tedious for users to transport and add to inefficiencies in shipping and handling.

In order to reduce the size of the charger, some battery chargers have been provided with collapsible-type housings which enable a user to collapse the battery charger into a reduced volume space. Previous collapsible chargers include a flip-type charger having a main housing containing the electrical charging circuitry and a pivoting flip tray portion that pivots to flip onto the upper surface of the main housing. In the open position, the flip tray defines a compartment of a fixed size to receive and charge a plurality of batteries of a predetermined size and type. The batteries engage charge contact terminals which apply the electrical charging current to each battery. When the battery charger is not used for charging, the flip tray is flipped over and onto the upper wall of the main housing, thereby consuming a reduced volume space.

While the conventional flip tray battery chargers offer a compact reduced volume package when not used for charging, such conventional battery chargers have drawbacks. One flip tray charger generally exposes electrical contacts when the flip tray is folded closed. The exposed electrical contacts may be damaged and/or corrode. Additionally, the flip tray charger typically employs exposed pivotal connections that are susceptible to damage.

### SUMMARY OF THE NVENTION

In accordance with the teachings of the present invention, a battery charger is provided for charging one or more batteries each having a pair of contact terminals on opposite ends. According to one aspect of the present invention, the battery charger includes a housing structure having a first upstanding wall and a sliding tray having a bottom wall and a second upstanding wall which is generally parallel to the first upstanding wall. The sliding tray is movable between a first position in which the first and second upstanding walls are adjacent to each other and a second position in which the first and second upstanding walls are spaced from one another. The tray is configured to hold one or more batteries for charging. The battery charger further includes at least one pair of contact terminals including a first contact provided on the first upstanding wall and a second contact provided on the second upstanding wall. The first and second contact terminals are adapted to contact the first and second contact terminals of a battery.

According to another aspect of the present invention, the battery charger includes a housing structure having walls defining a compartment and a sliding tray having a bottom wall and an upstanding wall. The battery charger also includes a sliding tray having a bottom wall and a second upstanding wall generally opposite the first upstanding wall. The sliding tray is moveable between a first position in which the first and second upstanding walls are adjacent to each other and a second position in which the first and second upstanding walls are spaced from one another. The tray is configured to hold one or more batteries for charging. The battery charger further includes at least one pair of contact terminals including a first contact provided in the first upstanding wall and a second contact provided in the second upstanding wall and adapted to contact the first and second contact terminals of a battery. The battery charger further includes an extendable contact member for adjusting the distance between the first and second contacts to accommodate different length batteries.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a perspective view of a sliding tray battery charger shown in the collapsed (closed) position absent batteries;

FIG. 2 is a perspective view of the battery charger shown in the open charging position with four identical size batteries illustrated in phantom;

FIG. 3 is a perspective view of the battery charger shown in the open charging position with two pairs of different size batteries shown in phantom;

FIG. 4 is a perspective view of the battery charger further illustrating the charge contact terminals in the sliding tray;

FIG. 5 is a top view of the sliding tray battery charger further shown in the open charging position;

FIG. 6 is a cross-sectional view of the battery charger taken through lines VI-VI of FIG. 5;

FIG. 7 is a cross-sectional view of the battery charger taken through lines VII-VII of FIG. 5;

FIG. 8 is a bottom view of the battery charger shown in the collapsed position with hidden electrical circuitry shown in phantom; and

FIG. 9 is a bottom view of the battery charger shown in the open charging position with the hidden electrical circuitry shown in phantom.

### DETAILED DESCRIPTION OF THE PREFERRED EMBODIMENT

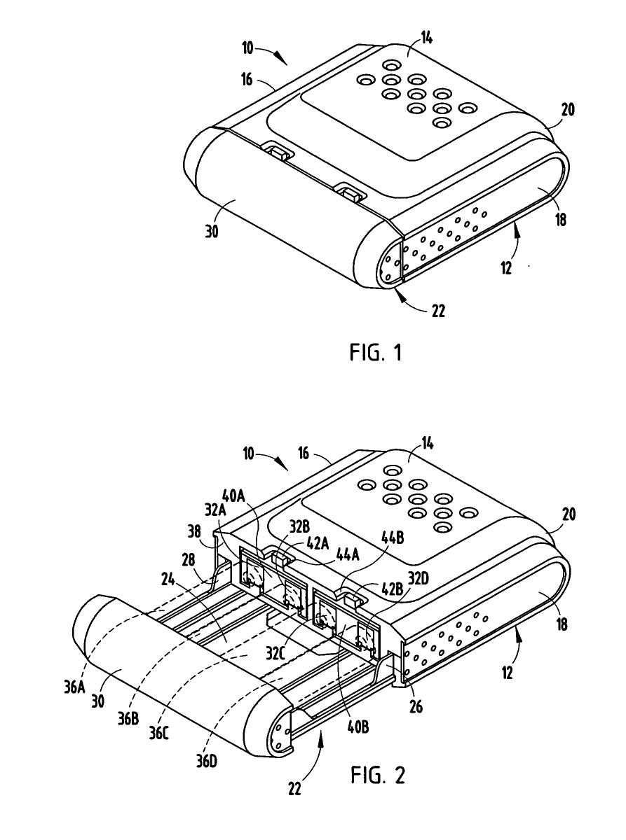

Referring to FIGS. 1 and 2, a sliding tray battery charger 10 is illustrated for charging four (4) rechargeable batteries 36A-36D, according to one embodiment of the present invention. The battery charger 10 is compact, collapsible, and adapted to hold and charge rechargeable (secondary) batteries, such as nickel-metal hydride batteries. While the charger 10 shown and described herein is configured to hold and charge up to four batteries 36A-36D, it should be appreciated that the charger 10 may be configured in various alternative shapes and sizes to hold and charge one or more rechargeable batteries of various types, shapes and sizes.

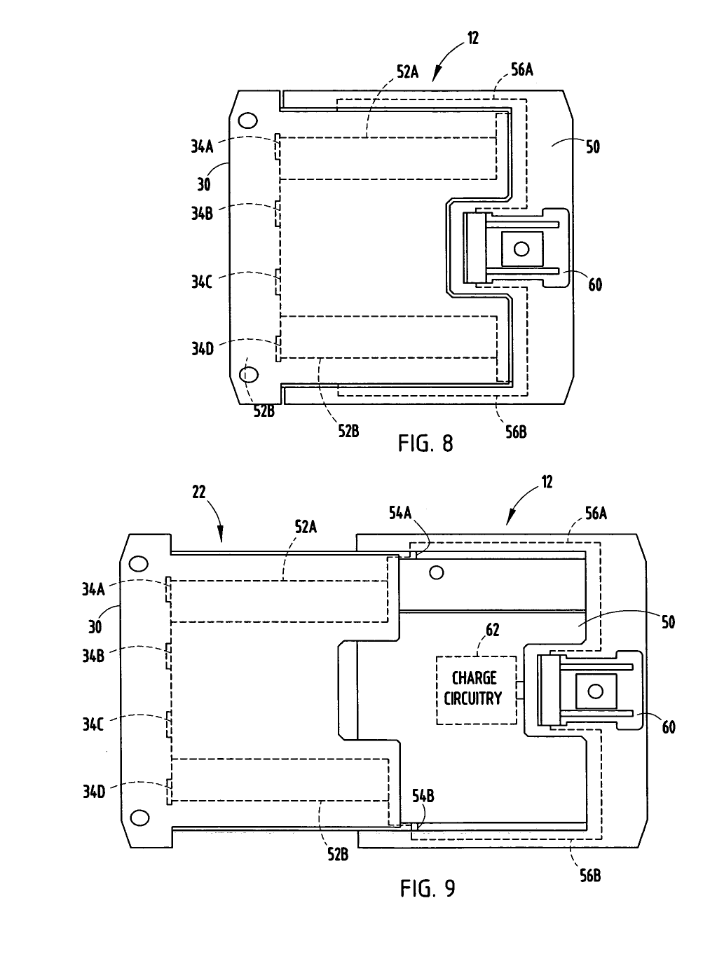

The battery charger 10 has a main housing 12 that houses electrical charging circuitry, including conventional electrical charge control circuitry to supply an electrical current to individual rechargeable batteries to be charged. The main housing 12 has an upper (top) wall 14, a lower (bottom) wall 50 (FIGS. 8 and 9), and upstanding side walls 16 and 18. Additionally, main housing 12 has a rounded rear wall 20 and a front upstanding wall 38. The upper and lower walls 14 and 50, side walls 16 and 18, and front and rear walls 38 and 20 generally define a closed compartment that houses the electrical charging circuitry 62 (FIG. 9). An electrical plug 60 (FIGS. 8 and 9) extends from the bottom wall 50 of the housing 12 and is adapted to matingly engage a conventional electrical power supply outlet. The electrical plug 60 is pivotal so that the two terminals can be rotated inward flush with the bottom wall 50 for enhanced compactness when not used for charging.

The battery charger 10 includes a sliding tray 22 that extends outward away from an upstanding wall 38 of the main housing 12 to provide a battery charging compartment when in the open charging position. The sliding tray 22 has a platform 24 and an upstanding forward wall 30 that slide outward and extend from main housing 12 when in the open position. Upstanding wall 30 has a rounded outside surface and an inner upstanding wall 48 that is generally parallel to upstanding wall 38. The battery compartment is generally defined by the space above the platform 24 between the first and second upstanding walls 48 and 38. Additionally, the sliding tray 22 may include side walls 26 and 28 which define side boundaries of the battery compartment.

The sliding tray battery charger 10 is compact when in its collapsed (closed) position in which the sliding tray 22 is retracted into the main housing 12 such that upstanding walls 38 and 48 are in a juxtaposition, adjacent to one another. The tray 22 is retractable such that the platform 24 slides onto the bottom wall 50 and the side walls 26 and 28 slide inside of walls 16 and 18. In the fully collapsed position, the battery compartment is substantially non-existent such that the battery charger 10 cannot hold and charge batteries.

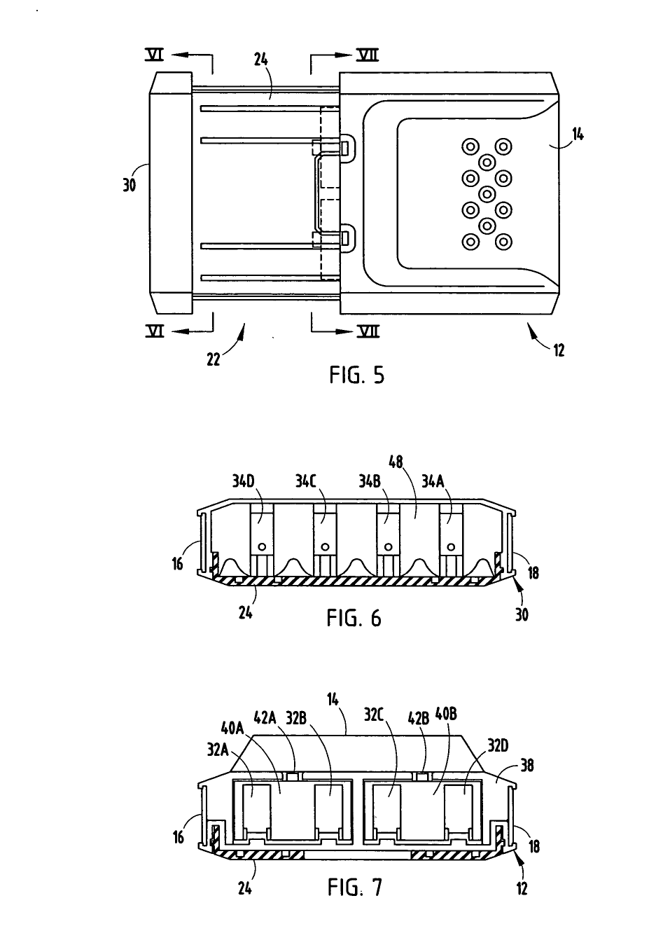

The sliding tray 22 extends outward and away from upstanding wall 38 as seen in FIGS. 2-5 into an open charging position to define the battery compartment for receiving batteries, such as four cylindrical rechargeable batteries 36A-36D. According to one example, batteries 36A-36D may include cylindrical AA-size nickel-metal hydride (Ni-MH) rechargeable batteries having positive and negative terminals provided on opposite ends of a cylindrical housing. Each battery 36A-36D has first and second terminals for contacting electrical charging contacts provided in the upstanding walls 38 and 48. The charging contacts include contacts 32A-32D (FIG. 7) provided on upstanding wall 38 of the main housing 12 and charging contacts 34A-34D (FIG. 6) provided on upstanding wall 48 of the sliding tray 22. Charging contacts 34A-34D are formed to include a bent metal spring bias for biasing each of batteries 36A-36D towards the opposing charging contacts 32A-32D. However, it should be appreciated that a bent metal or other spring bias may be provided in any or all of the charging contacts 32A-32D and 34A-34D to provide suitable frictional engagement to the opposing battery terminals.

The first pair of charging contacts 32A and 32B provided in upstanding wall 38 of housing 12 are provided on a first flip down contact adapter 40A. Likewise, the second pair of charging contacts 32C and 32D are likewise provided on upstanding wall 38 on a second flip down adapter 40B. Flip down adapter 40A has a tab 42A extending from the upper end that fits within a slot 47A in upper wall 14 of housing 12. Similarly, flip down adapter 40B has a tab 42B extending from the upper end which engages slot 44B in upper wall 14 when orientated in the upstanding position. Tabs 42A and 42B allow a user to engage and pivot the adapters 40A and 40B between vertical and horizontal positions.

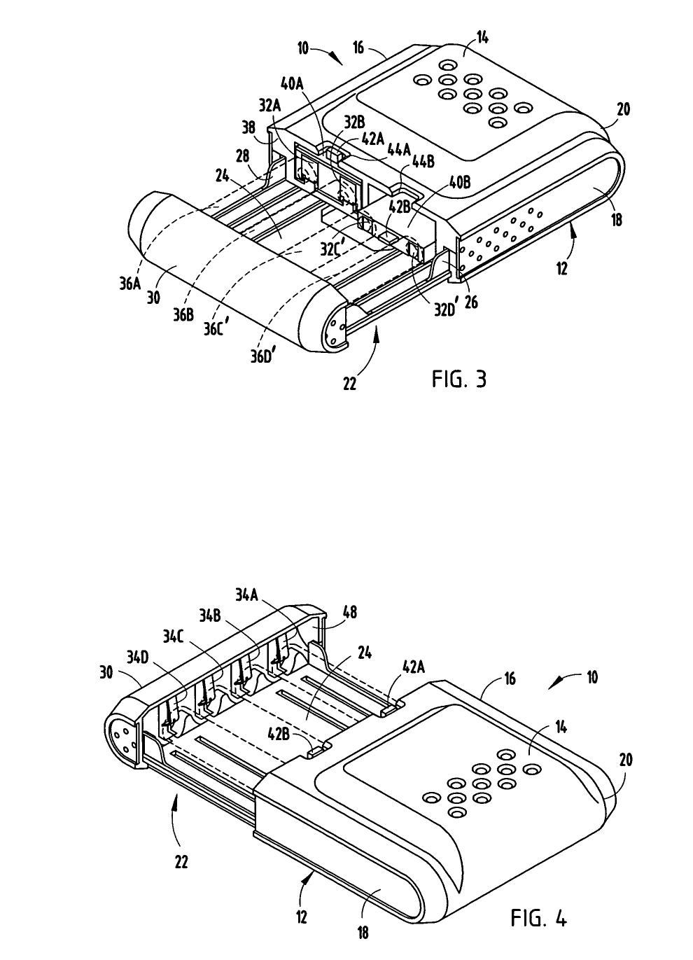

The flip down adapters 40A and 40B serve as extendable contact members that allow for a change in the length of the battery compartment between the first and second upstanding walls 48 and 38 and, hence, the distance between each of the pairs of first and second charging contacts 32A-32D and 34A-34D to accommodate different length batteries. By pivoting down one of the flip down contact adapters, such as flip down contact adapter 40B as shown in FIG. 3, the battery charger 10 can charge two different length batteries. For example, battery charger 10 can charge two AA-size batteries 36A and 36B with charge contacts 32A, 32B, 34A and 34B, while the adapter 40B allows for the charging of two smaller length batteries, such as two AAA-size batteries 36C′ and 36D′, with charge contacts 32C′, 32D′, 34C and 34D.

It should further be appreciated that the flip down adapter 40A could likewise be pivoted down to reduce the length of the battery compartment for batteries 36A and 36B. This would enable the simultaneous charging of up to four AAA-size batteries, according to one example. Hence, the battery charger 10 is adapted to charge various size batteries at the same or different times.

If different electrical charging currents and/or voltage potentials are required for different size/type batteries, the battery charger 10 may further include additional charge control circuitry to control the appropriate charging current and/or voltage applied to the batteries 36A-36D being charged. Such charge control circuitry may include the use of a sensing device to determine which size and/or type batteries are in the charger, or current sensing circuitry to determine characteristics (e.g., electrical resistance) of each battery being charged with the battery charger 10.

Referring to FIGS. 8 and 9, the battery charger 10 is further illustrated having electrical circuitry for providing the electrical circuit path for the charging current. According to one embodiment, the charging current, which is initially received from an electrical source via electrical plug 60, is applied to electrical circuitry coupled to the charge contacts 32A-32D in upstanding wall 38 of the main housing 12. During the charging operation, electrical current passes through each of the batteries to contacts 34A-34D and then through a return current circuit path. The return current circuit path is provided via electrical circuitry 52A and 52B electrically coupled to each of charge contacts 34A-34D. Electrical circuitry 52A is electrically coupled to electrical circuitry 56A via a first sliding contact 54A provided inside side wall 16 of the main housing 12. Similarly, electrical circuitry 52B is electrically coupled to circuitry 56B via a second sliding contact 54B provided inside side wall 18 of main housing 12.

The sliding contacts 54A and 54B slide in a track in conjunction with movement of the sliding tray 22 to move from the collapsed to the fully open charging position. When the sliding tray 22 is partially or fully collapsed (closed), the electrical circuit path is open-circuited to prevent current flow through the batteries. Once in the fully open charging position, sliding contacts 54A and 54B engage the electrical circuitry to form an electrical connection between circuit elements 52A and 56A and an electrical connection between circuitry 52B and 56B. This provides a closed electrical circuit path to enable charging of the batteries via battery charger 10.

The collapsible sliding tray battery charger 10 is operable to charge one or more batteries when in the open charging position, and is compact and easily transportable when in the collapsed position. In operation, the sliding tray 22 is extended from the collapsed position to the fully opened position to define battery compartments for receiving batteries to be charged. A user may insert one or more batteries having contact terminals on opposite ends into the battery compartment such that the contact terminals are in contact with opposing charge contacts 32A-32D and 34A-34D. One or both of the flip down contacts 40A and 40B may be rotated downward to accommodate smaller size batteries, if appropriate. With batteries arranged within the battery compartment and contacting the charge contacts 32A-32D and 34A-34D, the batteries are charged by applying electrical current to the batteries which is achieved by inserting electrical plug 60 into a suitable electrical outlet that supplies electric current. The charger 10 may include a charge indicator (not shown), such as a light to indicate whether the batteries are charging.

When the batteries are fully charged or no further charging is required, the batteries may be removed from the battery compartment and the battery charger 10 may be collapsed by retracting the tray 22 into the main housing 12 to its fully collapsed (closed) position. The collapsed battery charger 10 is compact and easily transportable. Additionally, the charge contacts 32A-32D and 34A-34D are covered up such that they are not exposed to the surrounding environment.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A battery charger for charging one or more batteries each having a pair of contact terminals provided on opposite ends, said battery charger comprising:
a housing structure having a first upstanding wall;
a sliding tray having a bottom wall and a second upstanding wall generally parallel to the first upstanding wall, wherein the sliding tray is movable between a first position in which the first and second upstanding walls are adjacent to each other and a second position in which the first and second upstanding walls are spaced from one another, and wherein the tray is configured to hold one or more batteries for charging; and
at least one pair of contacts including a first contact provided in the first upstanding wall and a second contact provided in the second upstanding wall, wherein the first and second contacts are adapted to contact the first and second contact terminals of a battery.

2. The battery charger as defined in claim 1 further comprising a sliding electrical contact coupling at least one of the first and second contacts to electrical circuitry in the housing.

3. The battery charger as defined in claim 1 further comprising an adapter formed in one of the first and second upstanding walls for changing distance between the first and second contacts to accommodate different size batteries.

4. The battery charger as defined in claim 3, wherein the battery charger charges AA-size batteries and AAA-size batteries.

5. The battery charger as defined in claim 1, wherein the tray holds substantially cylindrical batteries.

6. The battery charger as defined in claim 1, wherein the tray is fully collapsed in the first position and is fully open in the second position.

7. The battery charger as defined in claim 1, wherein one of the first and second contacts provides a spring bias for compressing a battery between the first and second contacts.

8. A battery charger for charging a plurality of batteries having a pair of contact terminals provided on opposite ends, said battery charger comprising:
a housing structure having a first upstanding wall;
a sliding tray having a bottom wall and a second upstanding wall generally parallel to the first upstanding wall, wherein the sliding tray is movable between a first position in which the first and second upstanding walls are adjacent to each other and a second position in which the first and second upstanding walls are spaced from one another, and wherein the tray is configured to hold a plurality of batteries for charging; and
a plurality of pairs of contacts including a first plurality of contacts provided in the first upstanding wall and a second plurality of contacts provided in the second upstanding wall, wherein the first and second contacts are adapted to contact the first and second contact terminals of a plurality of batteries.

9. The battery charger as defined in claim 8 further comprising a sliding electrical contact coupling at least one of the first and second plurality of contacts to electrical circuitry in the housing.

10. The battery charger as defined in claim 8 further comprising an adapter formed in one of the first and second upstanding walls for changing distance between at least one of the first plurality of contacts and at least one of the second plurality of contacts to accommodate different sized batteries.

11. The battery charger as defined in claim 10, wherein the battery charger charges a plurality of AA-size batteries and a plurality of AAA-size batteries.

12. The battery charger as defined in claim 8, wherein the tray holds substantially cylindrical batteries.

13. The battery charger as defined in claim 8, wherein the tray is fully collapsed in the first position and is fully opened in the second position.

14. The battery charger as defined in claim 8, wherein one of the first and second plurality of contacts provides a spring bias for compressing a battery between first and second contacts.

15. A battery charger for charging one or more batteries each having a pair of contact terminals provided on opposite ends, said battery charger comprising:
a housing structure having a first upstanding wall;
a sliding tray having a bottom wall and a second upstanding wall generally opposite the first upstanding wall, wherein the sliding tray is movable between a first position in which the first and second upstanding walls are adjacent to each other and a second position in which the first and second upstanding walls are spaced from one another, and wherein the tray is configured to hold one or more batteries for charging;
at least one pair of contacts including a first contact provided in the first upstanding wall and a second contact provided in the second upstanding wall and adapted to contact the first and second contact terminals of a battery; and
an extendable contact member for adjusting the distance between the first and second contacts to accommodate different length batteries.

16. The battery charger as defined in claim 15 further comprising a sliding electrical contact coupling at least one of the first and second contacts to electrical circuitry in the housing.

17. The battery charger as defined in claim 15, wherein the extendable contact member comprises a flip down adapter formed in one of the first and second upstanding walls for changing distance between the first and second contacts to accommodate different size batteries.

18. The battery charger as defined in claim 17, wherein the battery charger charges AA-size batteries and AAA-size batteries.

19. The battery charger as defined in claim 15, wherein the tray holds substantially cylindrical batteries.

20. The battery charger as defined in claim 15, wherein the tray is fully collapsed in the first position and is fully opened in the second position.

21. The battery charger as defined in claim 15, wherein one of the first and second contacts provides a spring bias for compressing a battery between the first and second contacts.
